(19) United States
(12) Patent Application Publication
(10) Pub. No.: US 2026/0201275 A1
(43) Pub. Date: Jul. 16, 2026

(54) PARTICULATE COMPOSITIONS

(71) Applicant: INNOSPEC LIMITED, Ellesmere Port (GB)

(72) Inventors: Alessandra ANDREOLI, Castiglione delle Stiviere (IT); Daniel BALLIS, Castiglione delle Stiviere (IT)

(21) Appl. No.: 19/138,165

(22) PCT Filed: Dec. 14, 2023
(86) PCT No.: PCT/EP2023/085916

§ 371 Date: Jun. 12, 2025

(30) Foreign Application Priority Data
Dec. 16, 2022 (GB) 2219079.7
Mar. 14, 2023 (GB) 2303738.5

(51) Int. Cl. C11D 1/90; C11D 3/33; C11D 17/00; C11D 17/06

(52) U.S. Cl. CPC C11D 1/90; C11D 3/33; C11D 17/0056; C11D 17/06

(57) ABSTRACT

A free flowing particulate composition including at least 50 wt % of one or more amphoteric surfactants and at least 0.1 wt % of one or more chelating agents.

The present invention relates to compositions useful in the preparation of detergent formulations and personal care compositions. In particular, the invention relates to solid compositions comprising amphoteric surfactants which are in free flowing particulate form.

It is highly desirable to provide detergent formulations and personal care compositions in solid form. Solid compositions are typically easier to handle than liquid compositions and have a reduced environmental impact compared with aqueous compositions, as unnecessary transport of water is avoided.

However a difficulty which arises during the manufacture of solid compositions is that many component ingredients are only commonly available as aqueous solutions.

One ingredient which is commonly used in detergent formulations and personal care compositions is cocamidopropyl betaine (or CAPB).

CAPB is a highly effective surfactant and may boost the performance of other surfactants present in a composition.

CAPB is commonly available as an aqueous solution, typically containing around 30 wt % active surfactant. Solid forms of CAPB are available but the material is highly hygroscopic meaning that material forms into solid cakes on storage. As a result the material is not available in a free flowing form and thus can be difficult to incorporate into formulations.

Free flowing particulate materials are easier to handle and dose than gels or lumpy solids and these are particularly desirable when forming compressed powder tablets and the like.

The present inventors have surprisingly found that the inclusion of a small amount of a chelating agent can improve or maintain the flowability of a solid composition comprising an amphoteric surfactant, especially after long term storage.

According to a first aspect of the present invention there is provided a free flowing particulate composition comprising at least 50 wt % of one or more amphoteric surfactants and at least 0.1 wt % of one or more chelating agents.

According to a second aspect of the present invention there is provided the use of one or more chelating agents to improve the flowability of a particulate composition comprising at least 50 wt % of one or more amphoteric surfactants.

Preferred features of the first and second aspects will now be described.

The free flowing particulate compositions are solid compositions, for example in the form of powders, agglomerates, granules, needles, or combinations thereof.

References to a solid composition, formulation or component herein refer to compositions, formulations or components which are in the solid state under normal atmospheric conditions (i.e. at a pressure of 1 atmosphere and 298 K).

The present invention relates to a free flowing particulate composition comprising one or more amphoteric surfactants.

By amphoteric surfactants, we mean to include any surfactants having the ability to exhibit both positive and negative sites. The one or more amphoteric surfactants may be selected from surfactants referred to as betaines, sultaines or zwitterionic surfactants or other amphoteric surfactants, for example those based on fatty nitrogen derivatives or amine oxides.

Suitable amphoteric surfactants for use herein may be selected from betaines, for example alkyl betaines, alkylamidopropyl betaines, alkylamidopropyl hydroxy sultaines, alkylampho acetates, alkylamphodiacetates, alkylamphopropionates, alkylamphodipropionates, alkyliminodipropionates and alkyliminodiacetate.

Suitable amphoteric surfactants for use herein may include those which have an alkyl or alkenyl group of 7 to 22 carbon atoms and comply with an overall structural formula:

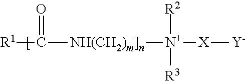

where R¹ is alkyl or alkenyl of 7 to 22 carbon atoms; R² and R³ are each independently alkyl, hydroxyalkyl or carboxyalkyl of 1 to 6 carbon atoms; m is 2 to 4; n is 0 or 1; X is alkylene of 1 to 6 carbon atoms optionally substituted with hydroxyl; and Y is —CO₂ or —SO₃.

Suitable amphoteric surfactants for use herein may include simple betaines of formula:

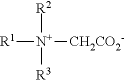

and amido betaines of formula:

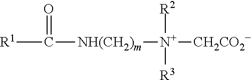

where m is 2 or 3.

In both formulae R¹, R² and R³ are as defined previously. R¹ may, in particular, be a mixture of C₁₂ and C₁₄ alkyl groups derived from coconut so that at least half, preferably at least 60%, of the groups R¹ has 10 to 14 carbon atoms. R² and R³ are preferably methyl.

In some embodiments substantially all of the groups R¹ have 12 carbon atoms.

In some embodiments substantially all of the groups R¹ have 14 carbon atoms.

In some embodiments substantially all of the groups R¹ have 16 carbon atoms.

In some embodiments substantially all of the groups R¹ have 18 carbon atoms.

The one or more amphoteric surfactants may include sultaines (or sulphobetaines) of formula:

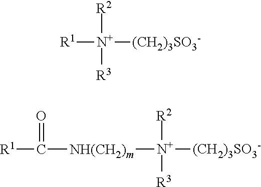

where m is 2 or 3, or variants of these in which
—(CH₂)₃SO₃ is replaced by

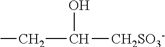

where R¹, R² and R³ in these formulae are as defined previously.

The one or more amphoteric surfactants may include amphoacetates and diamphoacetates. Amphoacetates generally conform to the following formula:

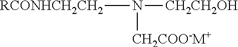

Diamphoacetates generally conform to the following formula:

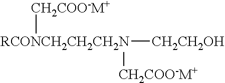

where R is an aliphatic group of 7 to 22 carbon atoms and M is a cation such as sodium, potassium, ammonium, or substituted ammonium.

Suitable acetate-based amphoteric surfactants include lauroamphoacetate; alkyl amphoacetate; cocoampho (di)acetate; cocoamphoacetate; disodium cocoamphodiacetate; sodium cocoamphoacetate; disodium cocoamphodiacetate; disodium capryloamphodiacete; disodium lauroamphoacetate; sodium lauroamphoacetate and disodium wheatgerm amphodiacetate.

Suitable betaine surfactants include alkylamido betaine; alkyl betaine, C_{12/14} alkyldimethyl betaine; cocoamidopropylbetaine; tallow bis(hydroxyethyl) betaine; hexadecyldimethylbetaine; cocodimethylbetaine; alkyl amido propyl sulfo betaine; alkyl dimethyl amine betaine; coco amido propyl dimethyl betaine; alkyl amido propyl dimethyl amine betaine; cocamidopropyl betaine; lauryl betaine; laurylamidopropyl betaine, coco amido betaine, lauryl amido betaine, alkyl amino betaine; alkyl amido betaine; coco betaine; lauryl betaine; dimethicone propyl PG-betaine; oleyl betaine; N-alkyldimethyl betaine; coco biguamide derivative, C_{8/10} amido betaine; C₁₀ amido betaine C₁₂ amido betaine; lauryl dimethyl betaine; alkylamide propyl betaine; amido betaine; alkyl betaine; cetyl betaine; oleamidopropyl betaine; isostearamidopropyl betaine; lauramidopropyl betaine; 2-alkyl-N-carboxymethyl-N-hydroxyethyl imidazolinium betaine; 2-alkyl-N-carboxyethyl-N-hydroxyethyl imidazolinium betaine; 2-alkyl-N-sodium carboxymethyl-N-carboxymethyl oxyethyl imidazolinium betaine; N-alkyl acid amidopropyl-N, N-dimethyl-N-(3-sulfopropyl)-ammonium-betaine; N-alkyl-N, N-dimethyl-N-(3-sulfopropyl)-ammonium-betaine; cocodimethyl betaine; apricotamidopropyl betaine; isostearamidopropyl betaine; myristamidopropyl betaine; palmitamidopropyl betaine; cocamidopropyl hydroxyl sultaine; undecylenamidopropyl betaine; cocoamidosulfobetaine; alkyl amido betaine; C_{12/18} alkyl amido propyl dimethyl amine betaine; lauryldimethyl betaine; ricinol amidobetaine; tallow aminobetaine.

Suitable glycinate-based amphoteric surfactants include cocoamphocarboxyglycinate; tallowamphocarboxygycinate; capryloamphocarboxyglycinate, oleoamphocarboxyglycinate, bis-2-hydroxyethyl tallow glycinate; lauryl amphoglycinate; tallow polyamphoglycinate; coco amphoglycinate; oleic polyamphoglycinate; N—C_{10/12} fatty acid amidoethyl-N-(2-hydroxyethyl)-glycinate; N—C_{12/18}-fatty acid amidoethyl-N-(2-hydroxyethyl)-glycinate; dihydroxyethyl tallow glycinate.

Suitable amine oxide surfactants for use herein include alkyl amine oxides of formula R¹R²R³N⁺O⁻ and acyl amine oxides of formula R¹CO(CH₂)ₙNR²R³N⁺O⁻ where R¹, R² and R³ are as previously defined and n is 1 to 6. Preferably n is 3, R² and R³ are both methyl and R¹ is an alkyl or alkenyl group of 10 to 18, preferably 12 to 16 carbon atoms.

Preferred acetate-based amphoteric surfactants for use herein include sodium lauroamphocaetate, disodium lauroamphoacetate and mixtures thereof.

Preferred betaine surfactants for use herein are amido betaines. Preferred amido betaines include lauryl amidopropyl betaine and cocoamidopropyl betaine. Especially preferred compounds include cocoamidopropyl betaine.

Preferred sultaine surfactants for use herein include amidoalkyl hydroxy sultaines, for example cocoamidopropylhydroxy sultaine.

Preferred amine oxide surfactants for use herein include lauramidopropyl amine oxide and alkyldimethyl amine oxide comprising mixed C12 to C16 alkyl groups.

Preferably the one or more amphoteric surfactants are selected from sultaines, betaines, amphoacetates, glycinate-based amphoteric surfactants, amine oxides and mixtures thereof.

Preferably the one or more amphoteric surfactants are selected from sultaines, betaines, amphoacetates, glycinate-based amphoteric surfactants and mixtures thereof.

Preferably the one or more amphoteric surfactants are selected from sultaines, betaines, amphoacetates, glycinate-based amphoteric surfactants and mixtures thereof.

The one or more amphoteric surfactants are preferably selected from betaine surfactants, sultaine surfactants, amphoacetate surfactants, amine oxides and mixtures thereof.

The one or more amphoteric surfactants are preferably selected from betaine surfactants, sultaine surfactants, amphoacetate surfactants, and mixtures thereof.

The one or more amphoteric surfactants are preferably selected from betaine surfactants.

Most preferably the one or more amphoteric surfactants comprises cocamidopropyl betaine (CAPB).

CAPB may be prepared from fatty acids, fatty acid esters and/or oils (glyceryl esters). Suitable feedstocks useful in the preparation of CAPB surfactants include coconut fatty acid; coconut oil; coconut oil methyl esters; virgin coconut oil; refined, bleached and deodorised coconut oil; palm oil; palm kernel oil; hydrogenated palm kernel oil derived C12-C18 fatty acids (hardened and topped fatty acid) and methyl esters thereof; and ‘distilled and topped’ hardened coconut fatty acid and methyl esters thereof.

The fatty acid distribution of some preferred feedstocks is as follows:

| | | Coconut oil | Palm kernel oil |
|---|---|---|---|
| Fatty Acid | Formula | (wt %) | (wt %) |
| Caproic | C₆H₁₂O₂ | 0.2-0.8 | 0-1 |
| Caprylic | C₈H₁₆O₂ | 6-9 | 3-5 |
| Capric | C₁₀H₂₀O₂ | 6-10 | 3-5 |
| Lauric | C₁₂H₂₄O₂ | 46-50 | 44-51 |
| Myristic | C₁₄H4₁₈₂O₂ | 17-19 | 15-17 |
| Palmitic | C₁₆H₃₂O₂ | 8-10 | 7-10 |
| Stearic | C₁₈H₃₆O₂ | 2-3 | 2-3 |
| Oleic | C₁₈H₃₄O₂ | 5-7 | 12-19 |
| linoleic | C₁₈H₃₂O₂ | 1-2.5 | 1-2 |

The free flowing particulate composition of the present invention comprises one or more amphoteric surfactants.

In some embodiments the composition may comprise one amphoteric surfactant.

In some embodiments the composition may comprise a mixture of two or more amphoteric surfactants.

The skilled person will appreciate that commercial sources of amphoteric surfactants often comprise mixtures of surfactant compounds, for example mixtures of homologues and/or isomers.

Commercial sources of amphoteric surfactants may also comprise impurities, by-products and/or unreacted starting materials.

The one or more amphoteric surfactants are present in the free flowing particulate composition in an amount of at least 50 wt %.

The one or more amphoteric surfactants may be present in the free flowing particulate composition in an amount of at least 55 wt %, preferably at least 60 wt %, suitably at least 65%, for example at least 70 wt %.

The one or more amphoteric surfactants may be present in the free flowing particulate composition in an amount of up to 99 wt %, preferably up to 95 wt %, suitably up to 90 wt %, preferably up to 85 wt %.

Preferably one or more amphoteric surfactants may be present in the free flowing particulate composition in an amount of from 50 to 97 wt %, preferably 60 to 90 wt %, more preferably 70 to 85 wt %.

The above amounts refer to the total amount of all amphoteric surfactants present in the composition.

For the avoidance of doubt the above amounts refer to the total amount active amphoteric surfactant compounds present in the composition, excluding any impurities and unreacted starting materials etc.

The free flowing particulate compositions of the present invention further comprise one or more chelating agents.

Any suitable chelating agent may be used.

Preferred chelating agents for use herein include aminocarboxylic acid chelating agents and amino phosphonic acid chelating agents. The active species provided in solution by such chelating agents are typically present in solution as the anionic aminocarboxylates or aminophosphonates. Polycarboxylic acid derived acid chelating agents are also suitable for use herein.

Suitable amino phosphonic acid-containing chelating agents having an amino functionality include organic amino phosphonic acids, such as the amino alkylene poly(alkylene phosphonic) acids. Preferred chelating agents of this type include ethylene diaminetetramethylene phosphonic acid and preferably diethylene triamine penta (methylene phosphonic acid), ethylene diamine tri (methylene phosphonic acid) and hexamethylene diaminetetra(methylene phosphonic acid). Such phosphonic acid chelating agents are commercially available under the tradename Dequest®, typically as a sodium salt thereof. A suitable chelating agent can be amino tri (methylene phosphonic acid).

Suitable amino carboxylic acid-containing chelating agents having an amino functionality for use in the present invention include polyaminocarboxylic acids for example ethylenediaminotetraacetic acid (EDTA), ethyenetriamine pentaacectic acid, ethylenediaminediglutaric acid, 2-hydroxypropylenediamine disuccinic acid, diethylene triamine pentaacetic acid (DTPA), N-hydroxyethylethylenediamine triacetic acid, ethylenediamine tetrapropionic acid, triethylenetetraaminehexa-acetic acid, ethanol-diglycines, propylene diamine tetracectic acid (PDTA) and methyl glycine diacectic acid (MGDA). Suitable amino carboxylic acids to be used herein are diethylene triamine penta acetic acid, propylene diamine tetracetic acid (PDTA) and methyl glycine di-acetic acid (MGDA).

Further suitable chelating agents for use herein are iminodiacetic acid derivatives such as 2-hydroxyethyl diacetic acid or glyceryl imino diacetic acid, described in EP-A-317,542 and EP-A-399,133. The iminodiacetic acid N-2-hydroxypropyl sulfonic acid and aspartic acid N-carboxymethyl N-2-hydroxypropyl-3-sulfonic acid chelating agents described in EP-A-516, 102 are also suitable herein. The β-alanine-N,N′-diacetic acid, aspartic acid-N,N′-diacetic acid, aspartic acid-N-monoacetic acid and iminodisuccinic acid sequestrants described in EP-A-509,382 are also suitable.

EP-A-476,257 describes suitable amino based chelating agents. EP-A-510,331 describes suitable chelating agents derived from collagen, keratin or casein. EP-A-528,859 describes a suitable alkyl iminodiacetic acid chelating agent. Glycinamide-N,N′ disuccinic acid (GADS), ethylenediamine-N, N′-diglutaric acid (EDDG) and 2-hydroxypropylenediamine-N—N′-disuccinic acid (HPDDS) are also suitable.

Preferably the one or more chelating agents are selected from 1-hydroxyethylidene-1,1-diphosphonic acid (HEDP), ethylenediamine disuccinic acid (EDDS), methylglycinediacetic acid (MGDA), glutamic acid, N,N-diacetic acid (GLDA), iminodisuccinic acid (IDS); ethylenediaminetetraacetic acid (EDTA), diethylenetriaminepentaacetic acid (DTPA), nitrilotriacetic acid (NTA), aspartic acid diethoxysuccinic acid (AES), aspartic acid-N,N-diacetic acid (ASDA), ethylenediamine tetra methylene phosphonic acid (EDTMP), iminodifumaric (IDF), iminoditartaric acid (IDT), iminodimaleic acid (IDMAL), iminodimalic acid (IDM), ethylenediaminedifumaric acid ethylenediaminedimalic acid (EDDM), (EDDF), ethylenediamineditartaric acid (EDDT), ethylenediaminedimaleic acid and (EDDMAL), aminotri(methylenephosphonic acid) (ATMP); diethylenetriamine-penta-methylene phosphonic acid (DETPMP), hydroxyethyliminodiacetic acid (HEIDA), aspartic acid diethoxysuccinic acid (AES), aspartic acid-N,N-diacetic acid (ASDA), diethylenetriaminepentamethylene-phosphonic acid (DTPMPA), hydroxyethylenediaminetetraacetic acid (HEDTA), hydroxyethylethylenediaminetriacetic acid (HEEDTA), glucoheptonic acid, citric acid, poly(acrylic-acid co-hypophosphite), tripolyphosphoric acid, polyacrylic acid and salts and mixtures thereof. Sodium salts of said acids are preferred.

In some embodiments the one or more chelating agents comprises tripolyphosphoric acid or a salt thereof, for example sodium tripolysphospate (STPP).

In some embodiments the one or more chelating agents comprises polyacrylic acid or a salt thereof.

Preferred chelating agents for use in the present invention are derivatives of polycarboxylic acids. By this we mean that the chelating agent includes two or more carboxylic acid moieties or salts thereof. Suitably chelating agents for use therein may include 3, 4 or 5 carboxylic acid moieties.

Preferably the one or more chelating agents are selected from iminodisuccinic acid (IDS), ethylenediaminetetraacetic acid (EDTA) diethylenetriaminepentaacetic acid (DTPA), hydroxyethylenediaminetetraacetic acid (HEDTA), hydroxyethylethylenediaminetriacetic acid (HEEDTA), iminodifumaric (IDF), iminoditartaric acid (IDT), iminodimaleic acid (IDMAL), iminodimalic acid (IDM), ethylenediaminedifumaric acid (EDDF), ethylenediaminedimalic acid (EDDM), ethylenediamineditartaric acid (EDDT), ethylenediaminedimaleic acid (EDDMAL) and aminotri(methylenephosphonic acid) (ATMP), citric acid, ethylene diamine disuccinic acid (EDDS) and salts and mixtures thereof, especially sodium salts thereof.

Suitably the one or more chelating agents may be selected from MGDA, GLDA, IDS, EDTA, DTPA, DETPMP, HEIDA, NTA, AES, ASDA, DTPMPA, STPP AND HEDTA.

Suitably the one or more chelating agents may be selected from MGDA, GLDA, IDS, EDTA, DTPA, DETPMP, HEIDA, NTA, AES, ASDA, DTPMPA AND HEDTA.

Preferably the one or more chelating agents are selected from MGDA, GLDA, IDS, EDTA, DTPA, DETPMP, HEIDA, EDDS, citric acid and salts and mixtures thereof.

Preferably the one or more chelating agents are selected from MGDA, GLDA, EDTA, EDDS, STPP, citric acid and salts and mixtures thereof.

Preferably the one or more chelating agents are selected from MGDA, GLDA, EDTA, EDDS, citric acid and salts and mixtures thereof.

Methylglycinediacetic acid (MGDA) has the structure shown in FIG. 1:

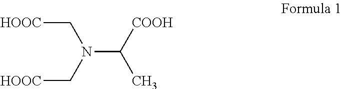

In the compositions of the present invention MGDA may be present having the structure shown in FIG. 1 and/or the same structure in which a number of the acidic protons have been replaced i.e. in which 1, 2 or 3 the acid groups have been neutralised or partially neutralised. It may be present as a free acid or a salt or complex thereof.

MGDA may be present as either enantiomer or a mixture thereof. Preferably it is present as a racemic mixture.

Preferably MGDA is provided as the trisodium salt.

MGDA is commercially available as a solution comprising 40 wt % of the trisodium salt and is sold under the trade mark Trilon M.

Glutamic acid N,N-diacetic acid (GLDA) has the structure shown in FIG. 2:

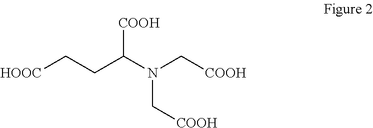 [SMILES: O=C(O)CCC(C(=O)O)N(CC(=O)O)CC(=O)O]

In the compositions of the present invention GLDA, may be present having the structure shown in FIG. 2 and/or the same structure in which a number of the acidic protons have been replaced, i.e. in which 1, 2, 3 or 4 of the acid groups have been neutralised or partially neutralised. It may be present as a free acid or a salt or complex thereof.

GLDA may be present as either enantiomer or a mixture thereof. Preferably at least 50% is present as [S]-GLDA, preferably at least 70%, more preferably at least 90%, most preferably at least 95 wt %, for example about 98 wt %. In some preferred embodiments the GLDA consists essentially of the S enantiomer.

GLDA is commercially available as a solution comprising 38 wt % of the tetrasodium salt and is sold under the trade mark Dissolvine GL-38.

DTPA has the structure shown in FIG. 3:

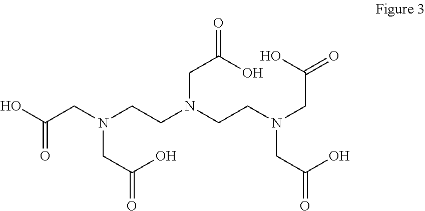 [SMILES: O=C(O)CN(CCN(CC(=O)O)CC(=O)O)CCN(CC(=O)O)CC(=O)O]

DTPA may be provided in a form having the structure shown in FIG. 3 or in a form having the same structure in which a number of the hydrogen atoms have been replaced, i.e. in which 1, 2, 3, 4 or 5 of the acid groups have been neutralised or partially neutralised.

When a salt of DTPA is included, this may be the salt of an alkali metal, an alkaline earth metal, ammonia or a suitable amine.

When a monovalent counterion is used the salt may be the monosalt, the disalt, the trisalt, the tetra salt or the pentasalt. For a divalent cation the monosalt or disalt may be present. Mixed salts may also exist, for example, the disodium magnesium salt or the sodium magnesium salt may be present. Preferably the counterion(s) to the DTPA residue is/are selected from one or more of sodium, magnesium, calcium, potassium, lithium, ammonium, and a quaternary ammonium ion.

Preferably DTPA when present is included as the pentasodium salt.

EDTA has the structure shown in FIG. 4:

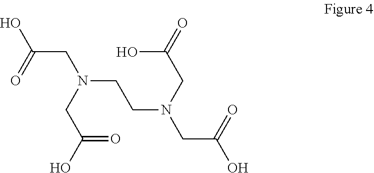 [SMILES: O=C(O)CN(CCN(CC(=O)O)CC(=O)O)CC(=O)O]

EDTA may be provided in a form having the structure shown in FIG. 4 or in a form having the same structure in which a number of the hydrogen atoms have been replaced, i.e. in which 1, 2, 3 or 4 of the acid groups have been neutralised or partially neutralised.

When a salt of EDTA is included, this may be the salt of an alkali metal, an alkaline earth metal, ammonia or a suitable amine.

When a monovalent counterion is used the salt may be the monosalt, the disalt, the trisalt or the tetrasalt. For a divalent cation the monosalt or disalt may be present. Mixed salts may also exist, for example, the disodium magnesium salt or the sodium magnesium salt may be present. Preferably the counterion(s) to the EDTA residue is/are selected from one or more of sodium, magnesium, calcium, potassium, lithium, ammonium, and a quaternary ammonium ion. Preferably EDTA when present is present as the tetrasodium salt, the trisodium salt or the disodium salt.

DETPMP has the structure shown in FIG. 5:

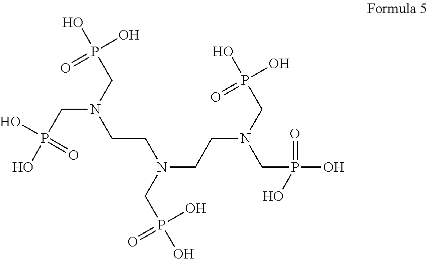 [SMILES: O=P(O)(O)CN(CCN(CP(=O)(O)O)CP(=O)(O)O)CCN(CP(=O)(O)O)CP(=O)(O)O]

This compound may also be referred to as DETPMP or DTPMP. It may be present as the free acid or a salt or complex thereof. DTPMPA is commercially available as the heptasodium salt form and is sold under the trade mark Dequest 2060 series.

Iminodisuccinic acid (IDS) has the structure shown in FIG. 6:

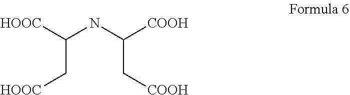 [SMILES: O=C(O)CC(NC(CC(=O)O)C(=O)O)C(=O)O]

In this specification IDS is used to refer to the structure shown in FIG. 6 and the same structure in which a number of the acidic protons have been replaced, i.e. in which 1, 2, 3 or 4 of the acid groups have been neutralised or partially neutralised.

IDS or a salt thereof may be present as either enantiomer or a mixture thereof. Preferably it is present as a racemic mixture.

IDS is commercially available as a solution comprising 34 wt % of the tetrasodium salt or a solid comprising at least 75 wt % active of the free acid and is sold under the trade mark Baypure CX100.

Hydroxyethyliminodiacetic acid (HEIDA) has the structure shown in FIG. 7:

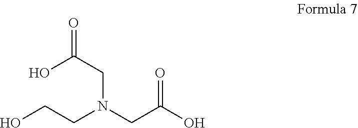 [SMILES: O=C(O)CN(CCO)CC(=O)O]

In this specification, the term HEIDA is used to refer to the structure shown in FIG. 7 and the same structure in which a number of the acidic protons have been replaced, i.e. in which 1 or 2 of the acid groups have been neutralised or partially neutralised.

ASDA is a structural isomer of IDS and has the structure shown in FIG. 8:

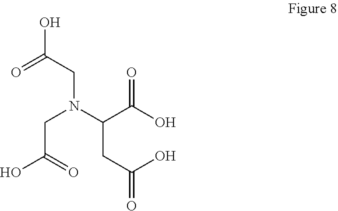 [SMILES: O=C(O)CC(C(=O)O)N(CC(=O)O)CC(=O)O]

In the compositions of the present invention ASDA may be present having the structure shown in FIG. 4 and/or the same structure in which a number of the acidic protons have been replaced, i.e. in which 1, 2, 3 or 4 of the acid groups have been neutralised or partially neutralised. It may be present as a free acid or a salt or complex thereof.

Ethylenediamine disuccinic acid (EDDS) which has the structure shown in FIG. 9:

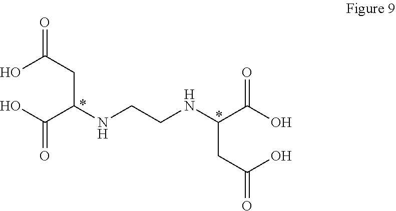 [SMILES: O=C(O)CC(NCCNC(CC(=O)O)C(=O)O)C(=O)O]

EDDS includes two stereogenic centres and there are three possible stereoisomers. A particularly preferred configuration is [S,S]-ethylenediamine disuccinic acid which is readily biodegradable.

In the compositions of the present invention EDDS may be present having the structure shown in FIG. 9 and/or the same structure in which a number of the hydrogen atoms have been replaced. Thus EDDS may also contain succinate salts in which 1, 2, 3 or 4 of the acid groups have been neutralised or partially neutralised. It may be present as a free acid or a salt or complex thereof.

One commercially available material is trisodium ethylenediamine disuccinate. The commercial product (Natriquest E30® or Enviomet C140®) is supplied as an aqueous solution comprising 30% by weight EDDS (expressed as free acid), or 37 wt % of the trisodium salt (including the counterion).

Another commercially available form of EDDS is the tetra acid, sold under the trade mark Natriquest E80®, Enviomet C265® or Enviomet 280®. This is provided as a powder which contains 80 wt % solid [S,S] EDDS as an acid and water of crystallisation.

Hydroxyethylethylenediaminetriacetic acid (known as HEEDTA or HEDTA) has the structure shown in FIG. 10:

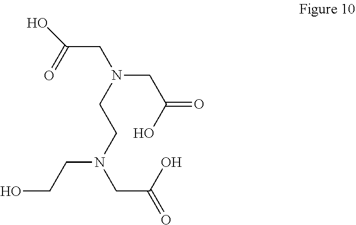 [SMILES: O=C(O)CN(CCO)CCN(CC(=O)O)CC(=O)O]

In the compositions of the present invention HEDTA may be present having the structure shown in FIG. 10 and/or the same structure in which a number of the acidic protons have been replaced, i.e. in which 1, 2 or 3 of the acid groups have been neutralised or partially neutralised. It may be present as a free acid or a salt or complex thereof.

HEDTA is commercially available as the trisodium salt under the trade mark Dissolvine H40.

Glucoheptonic acid may in some cases be used to describe a number of isomers. However the glucoheptonic acid used in the present invention suitably has the structure β-glucoheptonic acid shown in FIG. 11:

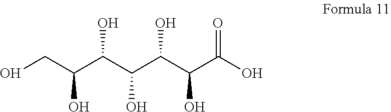 [SMILES: O=C(O)[C@@H](O)[C@@H](O)[C@H](O)[C@@H](O)[C@@H](O)CO]

This compound may exist in a number of stereoisomeric forms and any of the enantiomers and diastereomers thereof maybe used in the present invention. Two common commercially available forms are α-glucoheptonic acid and β-glucoheptonic acid. In the compositions of the present invention glucoheptonic acid is preferably present as β-glucoheptonic acid, that is the compound having the structure shown in FIG. 11. It may alternatively be present as a salt in which the acid group has been neutralised or a complex in which the acid group is complexed with another species.

The sodium salt of glucoheptonic acid is commercially available as a sodium salt or a boron complex and is sold under the trade mark Crodaquest.

In some embodiments the composition comprises poly(acrylic acid-co-hypophosphite) or a salt or complex thereof.

Poly(acrylic-acid co-hypophosphite) has the general structure shown in FIG. 12:

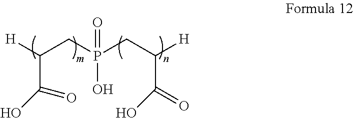

Typically, the molecular weight of the poly(acrylic acid co-hypophosphite) is less than 10,000, preferably less than 5,000, preferably less than 3,000. Preferably m is at least 1 and n may be 0 but is preferably at least 1. Preferably the sum of [m+n] is up to 135 and most preferably up to 40.

Poly(acrylic-acid co-hypophosphite) may be present in the form shown, or as the sodium or potassium salt or as a complex.

Suitable polymers are available under the brand name Belsperse.

In the compositions of the present invention poly(acrylic acid-co-hypophosphite) may be present in the form shown in FIG. 12 or it may be present as a salt or complex.

Poly(acrylic acid-co-hypophosphite) is commercially available and is sold under the trade mark Belsperse.

1-hydroxyethylidene-1,1-diphosphonic acid (HEDP) has the structure shown in FIG. 13:

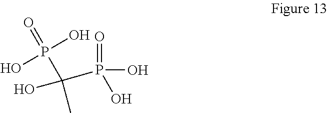

Commercially available HEDP is sold as a viscous yellow liquid comprising approximately 60 wt % active, and is highly acidic. It may be present in the compositions of the present invention as the free acid or a salt or complex thereof. Preferably it is added as the free acid.

Aminotri(methylenephosphonic acid) (ATMP) has the structure shown in FIG. 14:

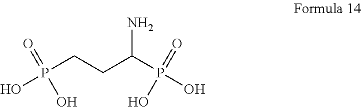 [SMILES: NC(CCP(=O)(O)O)P(=O)(O)O]

It may be present in the compositions of the present invention as the free acid or a salt or complex thereof. ATMP is commercially available as the free acid or the sodium salt. It is sold under the trade mark Dequest 2000 series.

Ethylenediamine tetra methylene phosphonic acid (EDTMP) has the structure shown in FIG. 15:

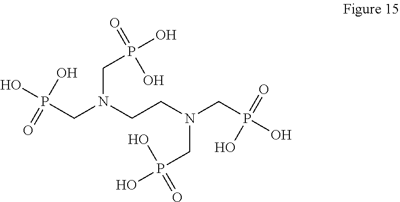 [SMILES: O=P(O)(O)CN(CCN(CP(=O)(O)O)CP(=O)(O)O)CP(=O)(O)O]

It may be present in the compositions of the present invention as the free acid or a salt or complex thereof. It is commercially available as the sodium salt under the trade mark Dequest 2040 series.

Citric acid has the structure shown in FIG. 16:

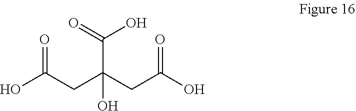 [SMILES: O=C(O)CC(O)(CC(=O)O)C(=O)O]

Citric acid may be included as the free acid or as an alkali metal or optionally substituted ammonium salt. For example citric acid may be present as a sodium, potassium or triethanolamine salt.

The one or more chelating agents are preferably present in the free flowing particulate composition of the present invention in an amount of at least 0.2 wt %, preferably at least 0.5 wt %, suitably at least 0.75 wt %, for example at least 1 wt %.

The one or more chelating agents are preferably present in the free flowing particulate composition of the present invention in an amount of up to 20 wt %, preferably up to 15 wt %, suitably up to 12 wt %, for example up to 10 wt %.

The one or more chelating agents are preferably present in the free flowing particulate composition of the present invention in an amount of from 0.1 to 20 wt %, preferably 0.5 to 20 wt %, suitably 0.5 to 15 wt %, preferably 1 to 10 wt %.

The free flowing particulate composition of the present invention may optionally comprise one or more further components in addition to the one or more amphoteric surfactants and one or more chelating agents.

In some embodiments the free flowing particulate composition further comprises sodium chloride.

Preferably sodium chloride is present in the free flowing particulate composition in an amount of from 0.1 to 40 wt %, preferably 1 to 30 wt %, suitably 5 to 25 wt %, preferably 10 to 20 wt %.

Preferably the free flowing particulate composition comprises less than 20 wt % water, preferably less than 15 wt %, more preferably less than 10 wt %, for example less than 5 wt % or less than 3 wt %.

Preferably the free flowing particulate composition comprises less than 1 wt % magnesium oxide, preferably less than 0.5 wt %, more preferably less than 0.1 wt %, for example less than 0.05 wt % or less than 0.01 wt %.

Preferably the free flowing compositions of the present invention comprise from 50 to 97 wt % of one or more amphoteric surfactants and from 0.1 to 30 wt % of one or more chelating agents.

Preferably the free flowing compositions of the present invention comprise from 50 to 97 wt % of one or more amphoteric surfactants; from 0.1 to 20 wt % of one or more chelating agents; from 0.1 to 40 wt % sodium chloride and up to 15 wt % water.

Suitably the free flowing compositions of the present invention comprise from 60 to 85 wt % of one or more amphoteric surfactants; from 0.1 to 10 wt % of one or more chelating agents; from 5 to 25 wt % sodium chloride and up to 10 wt % water.

Preferably the free flowing compositions of the present invention comprise from 50 to 97 wt % of one or more amphoteric surfactants selected from betaine surfactants, sultaine surfactants, amphoacetate surfactants, amine oxides and mixtures thereof; and from 0.1 to 30 wt % of one or more chelating agents.

Preferably the free flowing compositions of the present invention comprise from 50 to 97 wt % of one or more amphoteric surfactants selected from betaine surfactants, sultaine surfactants, amphoacetate surfactants, amine oxides and mixtures thereof; and from 0.5 to 20 wt %, preferably 0.5 to 15 wt % of one or more chelating agents.

Suitably the free flowing compositions of the present invention comprise from 60 to 85 wt % of one or more amphoteric surfactants selected from betaine surfactants, sultaine surfactants, amphoacetate surfactants, amine oxides and mixtures thereof; from 0.1 to 10 wt % of one or more chelating agents; from 5 to 25 wt % sodium chloride and up to 10 wt % water.

Preferably the free flowing compositions of the present invention comprise from 50 to 97 wt % of one or more amphoteric surfactants selected from betaine surfactants, sultaine surfactants, amphoacetate surfactants, amine oxides and mixtures thereof; and from 0.1 to 30 wt % of one or more chelating agents selected from MGDA, GLDA, IDS, EDTA, DTPA, DETPMP, HEIDA, EDDS, STPP, citric acid and salts and mixtures thereof.

Suitably the free flowing compositions of the present invention comprise from 60 to 85 wt % of one or more amphoteric surfactants selected from betaine surfactants, sultaine surfactants, amphoacetate surfactants, amine oxides and mixtures thereof; from 0.1 to 10 wt % of one or more chelating agents selected from MGDA, GLDA, IDS, EDTA, DTPA, DETPMP, HEIDA, EDDS, STPP, citric acid and salts and mixtures thereof; from 5 to 25 wt % sodium chloride and up to 10 wt % water.

Preferably the free flowing compositions of the present invention comprise from 50 to 97 wt % of one or more amphoteric surfactants selected from betaine surfactants, sultaine surfactants, amphoacetate surfactants, and mixtures thereof; and from 0.1 to 30 wt % of one or more chelating agents.

Suitably the free flowing compositions of the present invention comprise from 60 to 85 wt % of one or more amphoteric surfactants selected from betaine surfactants, sultaine surfactants, amphoacetate surfactants, and mixtures thereof; from 0.1 to 10 wt % of one or more chelating agents; from 5 to 25 wt % sodium chloride and up to 10 wt % water.

Preferably the free flowing compositions of the present invention comprise from 50 to 97 wt % of one or more amphoteric surfactants selected from betaine surfactants, sultaine surfactants, amphoacetate surfactants, and mixtures thereof; and from 0.1 to 30 wt % of one or more chelating agents selected from MGDA, GLDA, IDS, EDTA, DTPA, DETPMP, HEIDA, EDDS, citric acid and salts and mixtures thereof.

Suitably the free flowing compositions of the present invention comprise from 60 to 85 wt % of one or more amphoteric surfactants selected from betaine surfactants, sultaine surfactants, amphoacetate surfactants, and mixtures thereof; from 0.1 to 10 wt % of one or more chelating agents selected from MGDA, GLDA, IDS, EDTA, DTPA, DETPMP, HEIDA, EDDS, citric acid and salts and mixtures thereof; from 5 to 25 wt % sodium chloride and up to 10 wt % water.

Preferably the free flowing compositions of the present invention comprise from 50 to 97 wt % of one or more betaine surfactants; and from 0.1 to 30 wt % of one or more chelating agents selected from MGDA, GLDA, EDTA, EDDS, citric acid and salts and mixtures thereof.

Suitably the free flowing compositions of the present invention comprise from 60 to 85 wt % of cocamidopropyl betaine and mixtures thereof; from 0.1 to 10 wt % of one or more chelating agents selected from MGDA, GLDA, EDTA, EDDS, citric acid and salts and mixtures thereof; from 5 to 25 wt % sodium chloride and up to 10 wt % water.

Preferably the free flowing compositions of the present invention comprise from 50 to 97 wt % of one or more betaine surfactants; and from 0.1 to 30 wt % of one or more chelating agents selected from MGDA, GLDA, EDTA, EDDS, citric acid and salts and mixtures thereof.

Suitably the free flowing compositions of the present invention comprise from 60 to 85 wt % of cocamidopropyl betaine and mixtures thereof; from 0.1 to 10 wt % of one or more chelating agents selected from MGDA, GLDA, EDTA, EDDS, citric acid and salts and mixtures thereof; from 5 to 25 wt % sodium chloride and up to 10 wt % water.

In some embodiments the free flowing compositions of the present invention may comprise one or more further components. Such components will be known to those skilled in the art and include, for example, fillers and binding agents.

The particles of the free flowing particulate composition of the present invention preferably have an average particle size of from 10 to 5000 μm, preferably from 50 to 2000 μm, more preferably from 100 to 1500 μm, suitably from 150 to 1000 μm.

Average particle size is preferably measured by sieving techniques. One suitable method for determining average particle size is described in example 4.

The inventors have surprisingly found that the addition of small amounts of one or more chelating agents can improve the flowability of a particulate composition comprising amphoteric surfactants. In some cases the composition comprising the amphoteric surfactants maybe hygroscopic but when the chelating agent is present it maintains its free flowing form on storage, despite being hygroscopic.

Preferably the present invention provides a particulate composition which maintains its free flowing form on storage for at least one month under ambient conditions.

By ambient conditions we mean to refer to storage at atmospheric pressure and a temperature of from 15 to 25° C.

Preferably the particulate composition maintains its free flowing form on storage under ambient conditions for at least 3 months, preferably at least 6 months, for example at least 12 months.

Advantageously the particulate composition of the present invention has been found to maintain its free flowing form on storage for more than 12 months under conditions of varying temperature and humidity. For example a particulate composition of the present invention maintained its free flowing form on storage for more than 12 months under temperatures of 5 to 40° C. and up to 65% humidity.

This is particularly advantageous since the particulate composition can be stored and transported without needing any special conditions.

Preferably the particulate composition of the present invention does not form cakes of material on storing.

The flowability of a particulate composition may be measured by assessing the degree of caking. One suitable method is described in example 2. According to this method the degree of caking is the amount of powder appearing as lumps after keep a pressure for 1 hour with a 25 kg weigh and which cannot pass through a 2 mm sieve

Preferably the composition of the present invention has a degree of caking as measured by the method of example 2 of less than 20%, preferably less than 10%, more preferably less than 5%, suitably less than 2% or less than 1%.

The flowability of a particulate composition may be measured according to the procedure set out in example 3.

Preferably the composition of the present invention has a flowability as measured by the method of example 3 of at least 5 g/s, preferably at least 10 g/s, preferably at least 15 g/s, more preferably at least 20 g/s.

Preferably the composition of the present invention maintains a flowability after 6 months of storage as measured by the method of example 3 of at least 5 g/s, preferably at least 10 g/s, preferably at least 15 g/s, more preferably at least 20 g/s.

Preferably the composition of the present invention maintains a flowability after 24 months of storage as measured by the method of example 3 of at least 5 g/s, preferably at least 10 g/s.

According to a third aspect of the present invention there is provided a method of preparing a free flowing particulate composition of the first aspect, the method comprising:
(i) providing an aqueous composition comprising one or more amphoteric surfactants and one or more chelating agents; and
(ii) drying the composition obtained in step (i).

Preferred features of the third aspect are as defined in relation to the first and second aspects.

Step (i) involves providing an aqueous composition comprising one or more amphoteric surfactants and one or more chelating agents. The one or more amphoteric surfactants and one or more chelating agents are suitably provided in this composition in relative ratios to provide the desired ratio in the solid free flowing particulate composition. Suitable ratios are defined in relation to the first and second aspects.

In some embodiments step (i) may comprise mixing an aqueous solution of one or more amphoteric surfactants with an aqueous solution of one or more chelating agents.

In some embodiments step (i) may comprise mixing an aqueous solution of one or more amphoteric surfactants with one or more chelating agents in solid form.

In some embodiments step (i) may comprise mixing one or more amphoteric surfactants in solid form with an aqueous solution of one or more chelating agents.

In some embodiments step (i) may comprise adding water to one or more amphoteric surfactants in solid form and one or more chelating agents in solid form.

The aqueous solutions used in step (i) are preferably highly concentrated and may be saturated.

The method may comprise a step between step (i) and step (ii) of agitating the composition obtained in step (i) and or heating the composition obtained in step (i).

Step (ii) involves drying the composition obtained in step (i).

Any suitable drying means may be used in step (ii) and such means are known to the person skilled in the art.

In preferred embodiments step (ii) involves spray drying the composition obtained in step (i).

The free flowing particulate composition of the present invention is particularly useful in the preparation of detergent formulations and personal care compositions. Because the composition is free flowing it can be easily dosed into and mixed with other components.

The inclusion of a component in free flowing particulate form can be particularly useful in compositions where rapid dissolution is desirable.

According to a fourth aspect of the present invention there is provided a detergent formulation comprising a free flowing particulate composition comprising at least 50 wt % of one or more amphoteric surfactants and at least 0.1 wt % of one or more chelating agents.

Preferred features of the fourth aspect are as defined in relation to the first and second aspects.

The detergent formulation of the fourth aspect of the present invention may be useful in household cleaning, automatic dishwashing, manual dishwashing, laundry, fabric care, kitchen care, carpet cleaning, air fresheners, vehicle care, polishing products, machine cleaning and maintenance, pesticides, insecticides, fungicides, herbicides, oilfield chemical applications, marine applications, personal care and institutional/industrial cleaning.

In some preferred embodiments the detergent formulation of the fourth aspect is a personal care composition, preferably a solid personal care composition. For example the detergent formulation may be a solid shampoo bar, body wash, pre-shave formulation, soap bar, syndet bar or conditioner.

In some embodiments the personal care composition may be multifunctional. Solid personal care compositions are advantageous avoid the unnecessary transport of large volumes of water and can be packaged in a more environmentally friendly manner.

Further components suitable for inclusion in such compositions will be known to the person skilled in the art.

The detergent formulation of the fourth aspect of the present invention may be especially useful in household cleaning applications, especially in toilet care. The detergent formulation may be especially useful for cleansing a toilet, in particular a toilet bowl.

The detergent formulation of the fourth aspect of the present invention may be in solid form, i.e. may be a solid detergent formulation. The solid detergent formulation may itself be free flowing but this is not required. The solid detergent formulation may be in any suitable form, for example in the form of a solid bar, tablet, block, puck, stick, or sphere. The solid detergent formulation may be manufactured in a way known to a person skilled in the art, for example by compacting, pouring and moulding, or extruding.

The detergent formulation of the fourth aspect of the present invention may be a solid toilet block, such as a rim block or a cistern block.

In one preferred embodiment the present invention provides a solid toilet block (such as a rim block or a cistern block) comprising a free flowing particulate composition comprising at least 50 wt % of one or more amphoteric surfactants and at least 0.1 wt % of one or more chelating agents.

The free flowing particulate composition may be present in the detergent formulation (for example solid toilet block) in any suitable amount, such as in an amount of from 10 to 50 wt %, such as from 15 to 40 wt %, or from 17 to 35 wt %, based on the total weight of the detergent formulation.

The free flowing particulate composition may be present in the detergent formulation in an amount that provides from 5 to 90 wt %, such as from 8 to 40 wt %, or from 13 to 30 wt % of the amphoteric surfactant, based on the total weight of the detergent formulation.

The free flowing particulate composition may be present in the detergent formulation (for example solid toilet block) in any suitable amount, such as in an amount of from 0.1 to 20 wt %, such as from 0.5 to 10 wt %, or from 1 to 10 wt %, based on the total weight of the detergent formulation.

The free flowing particulate composition may be present in the detergent formulation in an amount that provides from 0.1 to 25 wt %, such as from 0.25 to 15 wt %, or from 0.5 to 10 wt %, of the amphoteric surfactant, based on the total weight of the detergent formulation.

The detergent formulation of the fourth aspect (such as a solid toilet block) may further comprise one or more additional components. Suitable such components will be known to the person skilled in the art.

Suitable further components include additional surfactants, preservatives, pH adjusting agents, fillers, perfumes and hydrotropes.

The nature of the additional components that may be present in the detergent formulations (such as solid toilet blocks) of the fourth aspect of the present invention will depend on the intended use of the detergent formulation.

In one preferred embodiment the present invention provides a solid detergent formulation (such as a solid toilet block) comprising a free flowing particulate composition comprising at least 50 wt % of one or more amphoteric surfactants and at least 0.1 wt % of one or more chelating agents.

Preferably the detergent formulation comprises less than 10 wt %, less than 5 wt % or less than 1 wt % of alkylbenzenesulfonates (linear and branched). Preferably the detergent formulation comprises less than 10 wt %, less than 5 wt % or less than 1 wt % of linear alkylbenzenesulfonates and preferably no branched alkylbenzenesulfonates. Preferably the detergent formulation may be substantially free, or completely free, of alkylbenzenesulfonates. Suitably the detergent formulation comprises no linear alkylbenzenesulfonates and no branched alkylbenzenesulfonates.

The detergent formulation (such as a solid toilet block) may comprise one or more further surfactants, such as one or more amphoteric, anionic and/or non-ionic surfactants, which may or may not be free flowing, preferably one or more anionic surfactants.

In some preferred embodiments the solid detergent formulation (such as a solid toilet block) further comprises a hydrocarbyl sulfate surfactant.

The hydrocarbyl sulfate may comprise an alkyl sulfate, an alkenyl sulfate, or a combination thereof. The hydrocarbyl sulfate may comprise a fatty alcohol sulfate. Suitably the hydrocarbyl sulfate may comprise a C₅ to C₃₀ alkyl or C₅ to C₃₀ alkenyl sulfate, such as a C₁₀ to C₂₀ alkyl or C₁₀ to C₂₀ alkenyl sulfate. The hydrocarbyl sulfate may comprise a C₅ to C₃₀ alkyl sulfate, preferably a C₁₀ to C₂₀ alkyl sulfate. The alkyl and/or alkenyl group(s) may be unsubstituted.

The hydrocarbyl sulfate may comprise a metallic hydrocarbyl sulfate and/or an amine derivative of a hydrocarbyl sulfate. By metallic hydrocarbyl sulfate we mean a hydrocarbyl sulfate comprising a metal cation. Typically, the hydrocarbyl sulfate comprises a metallic hydrocarbyl sulfate. The metallic hydrocarbyl sulfate may comprise a hydrocarbyl sulfate in which the cation is an alkali metal, such as sodium or potassium, or an alkali earth metal, such as magnesium. Preferably the metallic hydrocarbyl sulfate comprises a sodium hydrocarbyl sulfate. The amine derivative of a hydrocarbyl sulfate may comprise an ammonium hydrocarbyl sulfate, an alkyl amine hydrocarbyl sulfate, an alkanolamine hydrocarbyl sulfate, or a combination thereof.

Examples of suitable hydrocarbyl sulfates include sodium C₁₂ to C₁₆ alkyl sulfate (e.g. EMPICOL® LX series), sodium C₁₂ to C₁₈ alkyl sulfate (e.g. EMPICOL® LZ, CZ series), ammonium lauryl sulfate (e.g. EMPICOL® AL series), monoethanolamine lauryl sulfate (e.g. EMPICOL® LQ series), diethanolamine lauryl sulfate, triethanolamine lauryl sulfate (e.g. EMPICOL® TL series), monoisopropanolamine lauryl sulfate, diisopropanolamine lauryl sulfate, triisopropanolamine lauryl sulfate, magnesium lauryl sulfate, potassium lauryl sulfate, ammonium myristyl sulfate, monoethanolamine myristyl sulfate, diethanolamine myristyl sulfate, triethanolamine myristyl sulfate, sodium myristyl sulfate, ammonium cetyl sulfate, diethanolamine cetyl sulfate, sodium cetyl sulfate, sodium cetostearyl sulfate, ammonium coco-sulfate, sodium tallow sulfate, sodium oleyl sulfate, diethanolamine oleyl sulfate, sodium 2-ethylhexylsulfate (e.g. EMPICOL® 0585 series), sodium decyl sulfate (e.g. EMPICOL® 0758 series), sodium C₁₀ to C₁₂ fatty alcohol sulfate (e.g. EMPICOL® 0335 series), sodium C₅ to C₁₀ fatty alcohol sulfate, or a combination thereof. Surfactants under the name EMPICOL® are commercially available from Innospec.

Suitably, the hydrocarbyl sulfate may comprise sodium C₁₂ to C₁₆ alkyl sulfate (e.g. EMPICOL® LX series), sodium C₁₂ to C₁₈ alkyl sulfate (e.g. EMPICOL® LZ, CZ series), magnesium lauryl sulfate, potassium lauryl sulfate, sodium myristyl sulfate, sodium cetyl sulfate, sodium cetostearyl sulfate, sodium tallow sulfate, sodium oleyl sulfate, sodium decyl sulfate (e.g. EMPICOL® 0758 series), sodium C₁₀ to C₁₂ fatty alcohol sulfate (e.g. EMPICOL® 0335 series), sodium C₈ to C₁₀ fatty alcohol sulfate, or a combination thereof. Preferably, the hydrocarbyl sulfate may comprise sodium C₁₂ to C₁₆ alkyl sulfate (e.g. EMPICOL® LX series), sodium C₁₂ to C₁₈ alkyl sulfate (e.g. EMPICOL® LZ, CZ series), or a combination thereof.

When present, the hydrocarbyl sulfate may be present in the detergent formulation (for example solid toilet block) in any suitable amount, such as in an amount of from 5 to 50 wt %, such as from 10 to 40 wt %, or even from 12 to 35 wt %, based on the total weight of the detergent formulation.

In some preferred embodiments the detergent formulation (such as a solid toilet block) may be substantially free, or completely free, of hydrocarbyl sulfates.

In some preferred embodiments the detergent formulation (such as a solid toilet block) may be substantially free, or completely free, of alkylbenzenesulfonates.

In some preferred embodiments the detergent formulation (such as a solid toilet block) may be substantially free, or completely free, of hydrocarbyl sulfates and alkylbenzenesulfonates.

As used herein, the term “substantially free” means that the material being discussed is present in the formulation, if at all, as an incidental impurity. In other words, the material does not affect the properties of the formulation. As used herein, the term “completely free” means that the material being discussed is not present in the formulation at all.

In some preferred embodiments the detergent formulation (such as a solid toilet block) further comprises a taurate surfactant.

The detergent formulation may comprise an alkyl acyl taurate of formula (A):

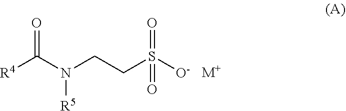

in which R⁴ is a C₅ to C₂₀ alkyl group, such as a C₁₀ to C₂₀ alkyl group, and R⁵ is a C₁ to C₂₀ alkyl group, such as a C₁ to C₄ alkyl group.

Each of R⁴ and R⁵ may be an unsubstituted alkyl group.

R⁴ is suitably the residue of a fatty acid. Fatty acids obtained from natural oils often include mixtures of fatty acids. For example, the fatty acid obtained from coconut oil contains a mixture of fatty acids including C₁₂ lauric acid, C₁₄ myristic acid, C₁₆ palmitic acid, C₈ caprylic acid, C₁₀ capric acid and C₁₈ stearic and oleic acid.

R⁴ may include the residue of one or more naturally occurring fatty acids and/or of one or more synthetic fatty acids. For example, R⁴ may consist essentially of the residue of a single fatty acid.

Examples of carboxylic acids from which R⁴ may be derived include coco acid, hexanoic acid, caproic acid, caprylic acid, capric acid, lauric acid, myristic acid, palmitic acid, palmitoleic acid, stearic acid, oleic acid, linoleic acid, arachidic acid, gadoleic acid, arachidonic acid, eicosapentanoic acid, behinic acid, erucic acid, docosahexanoic lignoceric acid, naturally occurring fatty acids such as those obtained from rice bran oil, oat oil, wheat germ oil, hemp seed oil, coconut oil, tallow, palm kernel oil, butterfat, palm oil, olive oil, corn oil, linseed oil, peanut oil, fish oil and rapeseed oil; synthetic fatty acids made as chains of a single length or a selected distribution of chain lengths; and mixtures thereof.

Preferably the compound of formula (A) comprises a methyl acyl taurate. Examples of suitable alkyl acyl taurates include sodium lauroyl methyl taurate, sodium methyl myristoyl taurate, sodium methyl palmitoyl taurate, sodium methyl stearoyl taurate, sodium methyl cocoyl taurate, sodium methyl oleoyl taurate, and combinations thereof.

Preferred taurate surfactants of formula (A) include sodium methyl oleoyl taurate, sodium methyl cocoyl taurate or mixtures thereof.

Alternatively and/or additionally the detergent formulation may comprise an alkyl acyl taurate of formula (B):

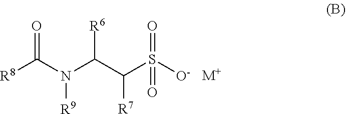

wherein:
R⁶ and R⁷ are each independently selected from H or C₁₋₄ alkyl, provided that one of R⁶ and R⁷ is H and the other of R⁶ and R⁷ is C₁₋₄ alkyl;
R⁹ is C₁₋₆ alkyl, C₂₋₆ alkenyl, or C₁₋₆ alkyl substituted with an aryl group; and
R⁸ is C₄₋₂₅ alkyl or C₄₋₂₅ alkenyl wherein the C₄₋₂₅ alkyl or C₄₋₂₅ alkenyl is optionally substituted by hydroxy.

Preferably one of R⁶ and R⁷ is C₁₄ alkyl and the other is H. More preferably one of R⁶ and R⁷ is methyl and the other is H.

Preferably R⁹ is C₁₋₆ alkyl or C₂₋₆ alkenyl, preferably C₁₋₆ alkyl, such as C₁₋₂ alkyl. More preferably, R⁹ is methyl.

R⁸ is preferably C₈₋₁₈ alkyl or C₈₋₁₈ alkenyl, wherein the C₈₋₁₈ alkyl or C₈₋₁₈ alkenyl is optionally substituted by hydroxy. Preferably R⁸ is an unsubstituted C₈₋₁₈ alkyl or an unsubstituted C₈₋₁₈ alkenyl.

R⁸ is suitably the residue of a fatty acid. Fatty acids obtained from natural oils often include mixtures of fatty acids. For example, the fatty acid obtained from coconut oil contains a mixture of fatty acids including C₁₂ lauric acid, C₁₄ myristic acid, C₁₆ palmitic acid, C₈ caprylic acid, C₁₀ capric acid and C₁₈ stearic and oleic acid.

R⁸ may include the residue of one or more naturally occurring fatty acids and/or of one or more synthetic fatty acids. For example, R⁸ may consist essentially of the residue of a single fatty acid.

Examples of carboxylic acids from which R⁸ may be derived include coco acid, hexanoic acid, caproic acid, caprylic acid, capric acid, lauric acid, myristic acid, palmitic acid, palmitoleic acid, stearic acid, oleic acid, linoleic acid, arachidic acid, gadoleic acid, arachidonic acid, eicosapentanoic acid, behinic acid, erucic acid, docosahexanoic lignoceric acid, naturally occurring fatty acids such as those obtained from rice bran oil, oat oil, wheat germ oil, hemp seed oil, coconut oil, tallow, palm kernel oil, butterfat, palm oil, olive oil, corn oil, linseed oil, peanut oil, fish oil and rapeseed oil; synthetic fatty acids made as chains of a single length or a selected distribution of chain lengths; and mixtures thereof.

Preferably R⁸ is an unsubstituted C₄₋₂₅ alkyl, such as an unsubstituted C₈₋₁₈ alkyl.

When present, the taurate (for example the alkyl acyl taurate) may be present in the detergent formulation (for example solid toilet block) in any suitable amount, such as in an amount of from 1 to 30 wt %, such as from 2 to 30 wt %, or even from 10 to 20 wt %, based on the total weight of the detergent formulation.

In some preferred embodiments the detergent formulation (such as a solid toilet block) further comprises a filler. The filler suitably comprises a carbonate salt, a sulfate salt, a halide salt, a phosphate salt, a silicate, or a combination thereof. The filler may comprise an alkali metal or alkaline earth metal carbonate salt, an alkali metal or alkaline earth metal sulfate salt, an alkali metal or alkaline earth metal halide salt, an alkali metal or alkaline earth metal phosphate salt, or a combination thereof. Suitable fillers include sodium sulfate, sodium chloride, sodium carbonate, and sodium silicate. Suitable fillers may be anhydrous or hydrated. Preferably, the filler is anhydrous.

The filler may be present in the detergent formulation (for example solid toilet block) in any suitable amount, such as in an amount of at least 10 wt %, such as at least 30 wt %, or even at least 50 wt %, based on the total weight of the detergent formulation. The filler may be present in the detergent formulation in an amount of from 10 to 90 wt %, such as from 30 to 70 wt %, or even from 50 to 60 wt % based on the total weight of the detergent formulation.

In some preferred embodiments the detergent formulation (such as a solid toilet block) further comprises a hydrocarbyl glucoside and/or a glycolipid, such as a sophorolipid, a rhamnolipid, and/or a mannosylerythritol lipid.

The detergent formulation may comprise a hydrocarbyl glucoside. The hydrocarbyl glucoside suitably comprises an alkyl glucoside, an alkenyl glucoside, or a combination thereof. The hydrocarbyl glucoside may comprise a fatty alcohol glucoside. Suitably the hydrocarbyl glucoside comprises a C₅ to C₃₀ alkyl or C₅ to C₃₀ alkenyl glucoside, such as a C₁₀ to C₂₀ alkyl or C₁₀ to C₂₀ alkenyl glucoside. The hydrocarbyl glucoside may comprise a C₅ to C₃₀ alkyl glucoside, such as a C₁₀ to C₂₀ alkyl glucoside. Examples of suitable hydrocarbyl glucosides include octyl glucoside, decyl glucoside, octyldecyl glucoside, undecyl glucoside, lauryl glucoside, myristyl glucoside, cetearyl glucoside, and coco-glucoside. A suitable example of a hydrocarbyl glucoside is lauryl glucoside.

The hydrocarbyl glucoside may be present in the detergent formulation (for example solid toilet block) in any suitable amount, such as in an amount of from 0.1 to 5 wt %, such as from 0.25 to 2 wt %, or even from 0.5 to 1 wt %, based on the total weight of the detergent formulation.

In some embodiments the detergent formulation (such as a solid toilet block) further comprises a non-ionic surfactant, such as a fatty alcohol ethoxylate.

In some preferred embodiments the detergent formulation (such as a solid toilet block) may be substantially free, or completely free, of fatty alcohol ethoxylates.

In some preferred embodiments the detergent formulation (such as a solid toilet block) further comprises an amphoteric surfactant (i.e. in addition to the amphoteric surfactant that is comprised in the free flowing particulate composition), such as a betaine (for example cocamidopropyl betaine (CAPB)). When such a further amphoteric surfactant is present, it maybe free flowing but this is not required. In some preferred embodiments, said additional amphoteric surfactant is not free flowing.

In some preferred embodiments the detergent formulation (such as a solid toilet block) further comprises a chelating agent (i.e. in addition to the chelating agent that is comprised in the free flowing particulate composition), such as a chelating agent as described herein (for example a chelating agent selected from MGDA, GLDA, IDS, EDTA, DTPA, DETPMP, HEIDA, EDDS, citric acid and salts and mixtures thereof, or a chelating agent selected from MGDA, GLDA, EDTA, EDDS, citric acid and salts and mixtures thereof).

The total chelating agent content of the detergent formulations (for example solid toilet blocks) may be from 2 to 5 wt %, wherein the chelating agent is present in both the free flowing particulate composition and by further addition thereof to the detergent formulation upon preparation thereof.

In some embodiments the detergent formulation may be a personal care composition, for example shampoos, body washes, soaps, beauty bars, creams and conditioners.

Personal care compositions typically comprise ingredients such as surfactants (including anionic, amphoteric, nonionic and cationic surfactants); conditioning agents (including quaternary ammonium compounds, cationic polymers, cationic conditioning polymers, silicones, synthetic or natural oils or resins etc), fatty alcohols, electrolytes or other rheology modifiers, opacifying/pearlising agents, scalp benefit agents, fragrances, dyes, UV filters, penetration enhancers (eg, propylene carbonate, benzyl alcohol etc), preservatives, antioxidants, emulsifiers, pH adjusting agents and buffers and styling polymers (eg, polyvinylpyrrolidone etc).

The personal care composition may comprise one or more of the surfactants previously defined herein. They may also comprise a cationic surfactant.

Suitable cationic polymers will be known to those skilled in the art and include multiple quaternary ammonium residues bonded to a polymeric backbone. Suitable cationic polymers include those known as polyquaterniums on the list of International Nomenclature for Cosmetic Ingredients (INCI list).

Preferred cationic polymers for use herein are polysaccharide compounds which have been functionalised with a cationic residue, such as quaternary ammonium group. Especially preferred cationic polymers are based on cellulose or guar gum. Compounds of this type will be known to the person skilled in the art.

Personal care compositions suitably comprise one or more ingredients selected from a sodium acyl isethionate (such as sodium lauroyl isethionate or sodium cocoyl isethionate), a sodium acyl alkyl isethionate (such as sodium lauroyl methyl isethionate or sodium cocoyl methyl isethionate), a sodium alkyl amphoacetate, disodium cocoamphodiacetate, an alkyl betaine, an alkamidopropyl betaine, an alkamidopropyl hydroxyl sultaine, an alkyl propionate, an alkyl sulfate, an alkyl ether sulfate, an alkyl sulfosuccinate, an alkyl ether sulfosuccinate, an acyl taurate (such as sodium lauroyl methyl taurate), an acyl glycinate, an acyl glutamate, an acyl sarcosinate, an alkyl polyglucoside, an acyl lactylate, a sodium acyl sulfoacetate, an aliphatic ester, an aromatic ester, a glycerol ester, an alcohol alkoxylate, a fatty acid alkoxylate, a biosurfactant (such as a sophorolipid), a fatty acid, or a mixture thereof.

In some preferred embodiments the detergent formulation (such as a solid toilet block) comprises:
from 10 to 50 wt %, such as from 17 to 35 wt %, of a free flowing particulate composition based on the total weight of the detergent formulation, wherein the free flowing particulate composition comprises at least 50 wt % of one or more amphoteric surfactants and at least 0.1 wt % of one or more chelating agents; and from 10 to 90 wt %, such as from 30 to 70 wt %, of a filler based on the total weight of the detergent formulation.

In some preferred embodiments the detergent formulation (such as a solid toilet block) comprises:
from 10 to 50 wt %, such as from 17 to 35 wt %, of a free flowing particulate composition based on the total weight of the detergent formulation, wherein the free flowing particulate composition comprises at least 50 wt % of one or more amphoteric surfactants and at least 0.1 wt % of one or more chelating agents;
from 10 to 90 wt %, such as from 30 to 70 wt %, of a filler based on the total weight of the detergent formulation; and
from 1 to 30 wt %, such as from 2 to 30 wt %, of a taurate surfactant (such as an alkyl acyl taurate) based on the total weight of the detergent formulation.

In some preferred embodiments the detergent formulation (such as a solid toilet block) comprises:
from 10 to 50 wt %, such as from 17 to 35 wt %, of a free flowing particulate composition based on the total weight of the detergent formulation, wherein the free flowing particulate composition comprises at least 50 wt % of one or more amphoteric surfactants and at least 0.1 wt % of one or more chelating agents;
from 10 to 90 wt %, such as from 30 to 70 wt %, of a filler based on the total weight of the detergent formulation; and
from 0.1 to 5 wt %, such as from 0.25 to 2 wt % of a hydrocarbyl glucoside based on the total weight of the detergent formulation.

In some preferred embodiments the detergent formulation (such as a solid toilet block) comprises:
from 10 to 50 wt %, such as from 17 to 35 wt %, of a free flowing particulate composition based on the total weight of the detergent formulation, wherein the free flowing particulate composition comprises at least 50 wt % of one or more amphoteric surfactants and at least 0.1 wt % of one or more chelating agents;
from 10 to 90 wt %, such as from 30 to 70 wt %, of a filler based on the total weight of the detergent formulation; and
from 1 to 5 wt %, such as from 2 to 4 wt %, of a chelating agent based on the total weight of the detergent formulation.

In some preferred embodiments the detergent formulation (such as a solid toilet block) comprises:
from 10 to 50 wt %, such as from 17 to 35 wt %, of a free flowing particulate composition based on the total weight of the detergent formulation, wherein the free flowing particulate composition comprises at least 50 wt % of one or more amphoteric surfactants and at least 0.1 wt % of one or more chelating agents;
from 10 to 90 wt %, such as from 30 to 70 wt %, of a filler based on the total weight of the detergent formulation;
from 1 to 30 wt %, such as from 2 to 30 wt %, of a taurate surfactant (such as an alkyl acyl taurate) based on the total weight of the detergent formulation; and
from 0.1 to 5 wt %, such as from 0.25 to 2 wt % of a hydrocarbyl glucoside based on the total weight of the detergent formulation.

In some preferred embodiments the detergent formulation (such as a solid toilet block) comprises:
from 10 to 50 wt %, such as from 17 to 35 wt %, of a free flowing particulate composition based on the total weight of the detergent formulation, wherein the free flowing particulate composition comprises at least 50 wt % of one or more amphoteric surfactants and at least 0.1 wt % of one or more chelating agents;
from 10 to 90 wt %, such as from 30 to 70 wt %, of a filler based on the total weight of the detergent formulation;
from 1 to 30 wt %, such as from 2 to 30 wt %, of a taurate surfactant (such as an alkyl acyl taurate) based on the total weight of the detergent formulation;
from 0.1 to 5 wt %, such as from 0.25 to 2 wt %, of a hydrocarbyl glucoside based on the total weight of the detergent formulation; and
from 1 to 5 wt %, such as from 2 to 4 wt %, of a chelating agent based on the total weight of the detergent formulation.

In some preferred embodiments the detergent formulation (such as a solid toilet block) comprises:
from 17 to 35 wt % of a free flowing particulate composition based on the total weight of the detergent formulation, wherein the free flowing particulate composition comprises at least 50 wt % of one or more amphoteric surfactants and at least 0.1 wt % of one or more chelating agents;
from to 50 to 60 wt % of a filler based on the total weight of the detergent formulation;
from 10 to 30 wt % of a taurate surfactant (such as an alkyl acyl taurate) based on the total weight of the detergent formulation; and
from 0.5 to 1 wt % of a hydrocarbyl glucoside based on the total weight of the detergent formulation.

In some preferred embodiments the detergent formulation (such as a solid toilet block) comprises:
from 17 to 35 wt % of a free flowing particulate composition based on the total weight of the detergent formulation, wherein the free flowing particulate composition comprises at least 50 wt % of one or more amphoteric surfactants and at least 0.1 wt % of one or more chelating agents;
from to 50 to 60 wt % of a filler based on the total weight of the detergent formulation;
from 10 to 30 wt % of a taurate surfactant (such as an alkyl acyl taurate) based on the total weight of the detergent formulation;
from 0.5 to 1 wt % of a hydrocarbyl glucoside based on the total weight of the detergent formulation; and
from 2 to 4 wt % of a chelating agent based on the total weight of the detergent formulation.

In the above mentioned preferred embodiments the detergent formulation may be substantially free, or completely free, of hydrocarbyl sulfates and/or of alkylbenzenesulfonates.

In the above mentioned preferred embodiments the detergent formulation may be substantially free, or completely free, of hydrocarbyl sulfates and/or of fatty alcohol ethoxylates.

In the above mentioned preferred embodiments the detergent formulation may be substantially free, or completely free, of hydrocarbyl sulfates, alkylbenzenesulfonates and fatty alcohol ethoxylates.

According to a fifth aspect of the present invention there is provided the use of a free flowing particulate composition comprising at least 50 wt % of one or more amphoteric surfactants and at least 0.1 wt % of one or more chelating agents in household cleaning (such as toilet care), manual dishwashing, laundry, fabric care, kitchen care, carpet cleaning, vehicle care, polishing products, machine cleaning and maintenance, pesticides, insecticides, fungicides, herbicides, oilfield chemical applications, marine applications, personal care or institutional/industrial cleaning formulations.

According to a sixth aspect of the present invention, there is provided a toilet cleansing device comprising the detergent formulation (preferably the solid detergent formulation) of the fourth aspect and an attachment element for attaching the device to a toilet. Suitably the device is attachable to the rim of a toilet bowl. The attachment element may be in the form of an arm or hook. The device may comprise a holder for holding the detergent formulation. The holder may be in the form of a housing such as a basket. When the toilet is flushed, water suitably contacts a portion of the detergent formulation, for example, by passing through the basket, to dissolve a portion of the detergent formulation and provide cleansing to the toilet.

According to a seventh aspect of the present invention, there is provided a method of providing cleansing to a toilet, the method comprising affixing the detergent formulation (preferably the solid detergent formulation, such as a solid toilet block, of the fourth aspect) to a toilet rim or placing the detergent formulation (preferably the solid detergent formulation, such as a solid toilet block, of the fourth aspect) within a toilet cistern.

Preferred features of the fifth, sixth and seventh aspects are as defined in relation to the first and second aspects. Preferred features of the detergent formulation apply when the detergent formulation is a solid toilet block (such as a rim block or a cistern block).

The invention will now be further defined with reference to the following non-limiting examples.

### EXAMPLE 1

Solid compositions were prepared comprising the ingredients listed in table 1.

TABLE 1

| Composition | 1 | 2 | 3 | 4 |
|---|---|---|---|---|
| CAPB (wt % | 76 | 73 | 79 | 76 |
| active) | | | | |
| Sodium citrate | | | 2.5 | |
| (wt % active) | | | | |
| Water (wt %) | 1.8 | 1.7 | 0.8 | 1.7 |
| NaCl (wt %) | 14.8 | 13.9 | 14.2 | 14.6 |
| MGDA (wt % | | 6 | | |
| active) | | | | |
| Other* (wt %) | To 100 | To 100 | To 100 | To 100 |

*Other components include unreacted starting materials and impurities present in commercial sources of the ingredients.

CAPB was derived from palm kernel oil comprising a mixture of C₁₂ to C₁₈ fatty acids.

MGDA was provided as the trisodium salt.

### EXAMPLE 2

The degree of caking of the compositions of example 1 were tested according to the following procedure. The results are shown in table 2.

### Compaction Test on Dried Products

### 1. Scope and Principle

This method is used to evaluate the degree of caking of dry products in powder, agglomerates, granules or needles form.

The degree of caking is defined as the proportion of powder appearing as lumps after applying pressure for 1 hour with a 25 kg weight and which cannot pass through a 2 mm sieve.

### 2. Apparatus

Plastic resealable bag (8×10 cm)
25 kg weight
2 mm Sieve

### 3. Analytical Procedure.

100 mL of the material to be analyzed was weighed (Wᵢ)

The material was closed it in a resealable plastic bag of 8×12 cm

A 25 Kg weight was placed on top of the bagged material for 1 hour

The weight of a 2 mm sieve was recorded

The bag was opened and the material poured on the 2 mm sieve

The sieve was gently shaken for 30 sec

The weight of the sieve and the quantity of product not passing through the sieve was recorded, and the initial weight of the sieve was subtracted from total weight (W_{f})

### 4. Plotting of the Results

The compacted material percentage (% C.M.) may be calculated using the formula:

$$\% C . M . = \frac{{W}_{f} \times 100}{{W}_{i}}$$

DEGREE OF CAKING

| | |
|---|---|
| Non-caking powder | <10% |
| Slightly caking powder | 10.1-20% |
| Caking powder | >20.1-50% |
| Very caking powder | >50% |
| Extremely caking powder | 100% |

TABLE 2

| Composition | 1 | 2 | 3 | 4 |
|---|---|---|---|---|
| Degree of | 68.5 | 0.8 | 0.0 | 74.3 |
| caking (%) | | | | |

### EXAMPLE 3

The flowability of the compositions of example 1 were assessed by the method below after a storage period of 6 or 24 months. The results are provided in table 3.

### Method for the Flowability Measurements of Dried Products

Instruments:
   Plastic tube, ø 4 cm, volume 500 mL.
   Support apparatus for the plastic tube (with a base containing a 1.5 cm hole and an opening/closing system)
   Empty container (to be placed under the instrument)
   Scale
   Stopwatch
Procedure:
   Insert the tube in the support apparatus and close the hole.
   Fill the tube with the dried product to be analysed (500 mL)
   Weigh the empty container and place it under the apparatus (Wᵢ).
   Open the hole and after the dried product starts to flow start the stopwatch; If the dried product is not immediately flowing, gently hit the base of the support
   When the dried product flow stops, stop the watch and record the time (t); if some dried product is still in the tube, after 10 seconds of not flowing, the base of the apparatus can be gently hit to help the flowing. If after 3 attempts the majority of the solid is still in the tube, the dried product is not flowable
   Weigh the container (W_{f}).
   The flowability will be measured using the formula:

$$Flowability = \frac{{W}_{f} - {W}_{i}}{t}$$

TABLE 3

| Composition | 1 | 2 | 3 | 4 |
|---|---|---|---|---|
| Storage period | 24 m | 24 m | 6 m | 6 m |
| Flowability | 0.7 | 22.4 | 24.4 | 0.1 |
| (g/s) | | | | |

The results in table 3 above of 22.4 g/s and 24.4 g/s for compositions 2 and 3 at 6 and 24 months illustrate excellent flowability. For the comparative compositions 1 and 4, very poor flowability was achieved.

### EXAMPLE 4

The average particle size of the compositions of the present invention may be determined according to the following method which is used to evaluate the granulometry of the solid material in a powder, agglomerate, granular or needle form.

### Apparatus:

Sieves at different mesh size:
   Plate, 75 μm, 125 μm, 250 μm, 500 μm, 1000 μm
Vibrating screen with a timer
Weight scale

### Analytical Procedure:

Take the sieves and weigh each of them
Stack the sieves starting from the one with smallest mesh and increasing the size.
Pour approx. 100 g of the dry product on the top sieve.
Place the sieves on the vibrating screen, cover with a lid and vibrate for 60 seconds.
Weigh each sieve again and record the data.
Subtract the weight of each sieve from the final weight of the sieves containing the powder.

The results can be normalized and plotted on a chart to illustrate the particle size distribution. In the example below, mesh size of each sieve is plotted on the X-axis and the amount of product found (in g) is plotted on the Y-axis.

### EXAMPLE 5

Solid toilet block formulations 5 to 8 were prepared comprising the ingredients listed in table 4. The amounts of each ingredient are given in wt % active.

For the preparation of the toilet block formulations, the solid ingredients shown in table 4 were weighed and added to the mixing chamber of a horizontal mixer having counter-rotating sigma blades and mixed to achieve a homogeneous mixture. The mixing speed was 10 rpm, and the mixing chamber temperature was set to 25° C. The liquid ingredients shown in Table 4 were then weighed and added to the premixed solid ingredients under mixing. The mixer was stopped once a homogeneous granular mixture had been obtained. The granular mixture was then added to a single-screw plodder machine and extruded in the desired shape using a screw speed of 1 rpm. The temperatures of the barrel and the conical head of the plodder were set to 18.5° C. and 30° C., respectively. The extrudability of the composition was deemed to be “OK” if the mixture maintained its shape and did not crack or fall apart during extrusion.

TABLE 4

| Composition | 5 | 6 | 7 | 8 |
|---|---|---|---|---|
| Na₂SO₄ anhydrous | 56.25 | 54.25 | 56.25 | 54.25 |
| Sodium citrate tribasic dihydrate | 3 | 3 | 3 | 3 |
| sodium carbonate anhydrous | 1.5 | 1.5 | 1.5 | 1.5 |
| Sodium Methyl Oleoyl Taurate ^{[1]} | 0 | 13.65 | 0 | 13.65 |
| Cocamidopropyl betaine | 27.3 | 13.65 | 27.3 | 13.65 |
| (present as free flowing | | | | |
| particulate composition of the | | | | |
| invention) ^{[2]} | | | | |
| Lauryl Glucoside ^{[3]} | 0.62 | 0.62 | 0 | 0 |
| Cocamidopropyl betaine ^{[4]} | 0 | 0 | 0.44 | 0.22 |
| Sodium Methyl Oleoyl Taurate ^{[5]} | 0 | 0 | 0 | 0.19 |
| Perfume | 3 | 3 | 3 | 3 |
| Mixing Time (min) | 85 | 45 | 80 | 30 |
| Extrudability | OK | OK | OK | OK |
| Flash Foam (mL) (Time 0 Sec) | 183 | 87 | 151 | 62 |
| Stable Foam (mL) (Time 300 | 171 | 80 | 142 | 58 |
| sec) | | | | |
| Life span (No flushes) | 143 | 237 | 126 | 237 |

^{[1]} commercially available as a powder comprising 70 wt % active material
^{[2]} solid free flowing Composition 3 of Example 1 comprising 79 wt % active material
^{[3]} commercially available as a liquid comprising 50 wt % active material
^{[4]} commercially available as a liquid comprising 35 wt % active material
^{[5]} commercially available as a liquid comprising 30 wt % active material

The flash foam test was conducted as follows:

### Foam Test

The foaming profile of the formulations in Table 4 was tested using the well-known Ross Miles pouring foam method (J. Ross, G. D. Miles: An Apparatus for Comparison of Foaming Properties of Soaps and Detergents, Oil & Soap, May 1941, P. 99-102.) according to ASTM D1173-53 (2001) “Foaming properties of Surface Active Agents” and UNI26001 “Cosmetic And Personal Hygiene Products-Foaming Power Determination Of Detergent Products Containing Surface Active Agents”, 1995.

The conditions of the test were as follows:

| | |
|---|---|
| Toilet Block concentration | approx. 0.18 g/L as w/w |
| Water hardness | approx. 330 ppm CaCO₃ (tap water) |
| Water temperature | 15° C. |
| Repetitions | 3 |
| Measuring time of the foam | 0 sec, 60 sec, 300 sec |
| Units of foam volume | mL |

The foaming properties of the solid toilet block formulations are reported in table 4 as flash foam (initial foam mL at time 0 sec) and as stable foam (foam mL after 300 sec).

The lifespan test was conducted as follows:

### Lifespan Test

The lifespan of formulations in table 4 was tested by flushing a toilet 18 flushes/day at random intervals to which a cage had been attached at the rim which contained 1×35 g block of the formulation. The toilet was a Duravit Duraplus Sudan model having an approx. 6 L flush. The water hardness was approx. 330 ppm CaCO₃ (tap water) and the water temperature was approx. 15±5° C.

The lifespan was determined as the point at which the formulations were completely used up.

### EXAMPLE 6

Further solid compositions were prepared comprising the ingredients listed in table 5:

TABLE 5

| Composition | 9 | 10 | 11 | 12 | 13 | 14 | 15 | 16 | 17 |
|---|---|---|---|---|---|---|---|---|---|
| CAPB | 74 | 74 | 74 | | | 80 | 72 | | |
| (wt % active) | | | | | | | | | |
| LAPB¹ | | | | 95 | 87.5 | | | | |
| (wt % active) | | | | | | | | | |
| LAPO² | | | | | | | | 90.8 | |
| (wt % active) | | | | | | | | | |
| LAA³ | | | | | | | | | 54 |
| (wt % active) | | | | | | | | | |
| Sodium | | | | | | 2.5 | 3.8 | 1.5 | 1.8 |
| citrate | | | | | | | | | |
| (wt % active) | | | | | | | | | |
| NaCl | 14.1 | 14.3 | 14 | <1 | <1 | 14.5 | 14.2 | | 16.2 |
| (wt %) | | | | | | | | | |
| water | 1.2 | 1.1 | 1.4 | 3.6 | 4.1 | 0.5 | 1.7 | 1.8 | 2.3 |
| (wt %) | | | | | | | | | |
| Sodium | | | | | 2 | | | | 10.3 |
| sulfate | | | | | | | | | |
| (wt %) | | | | | | | | | |
| MGDA | 5 | | | | 6.2 | | | 2.5 | 5 |
| (wt % active) | | | | | | | | | |
| STPP | | 5 | | | | | | | |
| (wt % active) | | | | | | | | | |
| EDDS | | | 5 | | | | | | |
| (wt % active) | | | | | | | | | |
| glycerol | | | | | | | 6.3 | | |
| (wt %) | | | | | | | | | |
| Sodium | | | | | | | | | 9.8 |
| carbonate | | | | | | | | | |
| (wt %) | | | | | | | | | |
| Other* | To 100 | To 100 | To 100 | To 100 | To 100 | To 100 | To 100 | To 100 | To 100 |
| (wt %) | | | | | | | | | |

*Other components include unreacted starting materials and impurities present in commercial sources of the ingredients.
¹lauryl amido propyl betaine (desalted)
²Lauramidopropyl amine oxide
³sodium lauroamphoacetate

### EXAMPLE 7

The compositions of example 6 were tested shortly after preparation according to the methods described in examples 2 and 3 to determine the degree of caking and flowability. The result are shown in table. The results, and the appearance of these compositions is detailed in table 6.

TABLE 6

| | | Flowability | Degree of |
|---|---|---|---|
| Example | Appearance | (g/s) | caking (%) |
| 9 | Granules | 25.7 | <1 |
| 10 | Granules | 27.8 | <1 |
| 11 | Granules | 23.4 | <1 |
| 12 (comparative) | Fine powder | <5 | 62.7 |
| 13 | Fine powder | 15.8 | <1 |
| 14 | Small granules | 26 | <1 |
| 15 | Fine powder/granules | 17.3 | <1 |
| 16 | Small granules | 16.5 | <1 |
| 17 | Small granules | 33.6 | <1 |

### EXAMPLE 8

A further solid composition of the invention was prepared comprising cocamidopropyl hydroxysultaine (75 wt %), MGDA (4 wt %) sodium citrate (1 wt %), water (4.2 wt %) and sodium chloride (13.8 wt %). The remaining material is from impurities or residual starting materials in the components.

### EXAMPLE 9

A multifunctional hair, body and beard formulation was prepared which may be used as a shampoo, conditioner, body wash, face wash & pre-shave composition.

The composition contained the following ingredients:

| Ingredient | Wt % active |
|---|---|
| Sodium lauroyl methyl isethionate | 10.72 |
| Glycerin | 26.5 |
| Guar hydroxypropyltrimonium chloride | 0.50 |
| Composition 1 of example 3 | 5.00 |
| (Cocamidopropyl betaine) | |
| Sodium cocoyl isethionate | 25.93 |
| Propoxytetramethyl piperidinyl dimethicone | 2.00 |
| Phenoxyethanol | 1.00 |
| Fragrance | 1.00 |
| Others* | To 100 |

*Other components include unreacted starting materials and impurities present in commercial sources of the ingredients.

The composition can be provided in the form of a butter, paste, pomade or thick cream.

The composition provides a high-quality, creamy lather foam, with mild ingredients and desirable after feel.

Advantages of the composition include that is can be provided in reduced packaging or a sustainable packaging, it contains less water than traditional products, it is sulfate free and is multifunctional.

### EXAMPLE 10

The following solid shampoo formulations were prepared comprising the following components.

| Composition | 20 | 21 | 22 | 23 | 24 |
|---|---|---|---|---|---|
| Microcrystalline Cellulose | 25.00 | 25.00 | 25.00 | — | — |
| (wt % active) | | | | | |
| Sodium coco sulfate | 39.38 | 39.38 | 39.38 | 85.82 | 85.82 |
| (wt % active) | | | | | |
| D-Manitol (wt % active) | 25.00 | 25.00 | 25.00 | — | — |
| Guar Hydroxypropyltrimonium | 0.30 | 0.30 | 0.30 | 0.30 | 0.30 |
| Chloride (wt % active) | | | | | |
| Water | 3.60 | 5.60 | — | — | 2 |
| Composition 3 of example 1 | 3.00 | 1.00 | 6.60 | 3 | 1 |
| (Cocamidopropyl betaine) | | | | | |
| Fragrance | 0.30 | 0.30 | 0.30 | 0.3 | 0.3 |
| Argan oil | — | — | — | 3 | 3 |
| Others* | To 100 | To 100 | To 100 | To 100 | To 100 |
| Appearance | Tablet | Bar | Tablet | Bar | Bar |

*Other components include unreacted starting materials and impurities present in commercial sources of the ingredients.

### EXAMPLE 11

Two drain cleaning compositions were prepared comprising the following components:

| | Formulation 1 | Formulation 2 |
|---|---|---|
| Ingredient | (wt % active) | (wt % active) |
| Citric Acid | 50 | 50 |
| Sodium Carbonate | 20 | 20 |
| Sodium dichloroisocianurate | \ | 10 |
| Sodium Percarbonate | 10 | \ |
| TAED¹ | 1 | \ |
| Composition 3 of example 1 | 4 | 4 |
| (Cocamidopropyl betaine) | | |
| MGDA | 6 | 6 |
| Probiotics | 2 | \ |
| Sodium Xylenesulfonate | 1.9 | 1.9 |
| Sodium Chloride | 4 | 7 |
| Others* | To 100 | To 100 |
| pH Sol 5% | 4.5 | 4.7 |

*Other components include unreacted starting materials and impurities present in commercial sources of the ingredients.
¹Tetraacetylethylenediamine

The compositions were prepared by admixing all of the ingredients at ambient temperature until a homogeneous composition was obtained in the form of a powder.

In use the composition is directed adding to a sink with warm water.

### EXAMPLE 12

A toilet block composition was prepared by admixing the components listed in the table below until homogenized, extruding and then cutting into blocks.

| Ingredient | Wt % active |
|---|---|
| Sodium sulfate | 43.45 |
| Sodium citrate | 3 |
| Sodium carbonate | 1.5 |
| Sodium methyl oleoyl taurate | 3.5 |
| Composition 3 of example 1 | 7.6 |
| (Cocamidopropyl betaine) | |
| Lauryl glucoside | 0.15 |
| Cetyl stearyl alcohol | 2 |
| Sodium C12-16 sulfate | 30.4 |
| Perfume | 3 |
| Others* | to 100 |

*Other components include unreacted starting materials and impurities present in commercial sources of the ingredients.

Sodium methyl oleoyl taurate was provided as a powder comprising 70 wt % active material.

Lauryl glucoside was provided as a solution comprising 50 wt % active material.

Cetyl stearyl alcohol was provided as a flake comprising 90 wt % active material

Sodium C12-16 sulfate was provided as a powder comprising 95 wt % active material.

### EXAMPLE 13

An effervescent toilet cleaner was provided comprising the following components:

| Ingredient | Wt % active |
|---|---|
| Anhydrous citric acid | 45 |
| Sodium Carbonate | 46 |
| Composition 3 of example 1 | 4 |
| Sodium Xylenesulfonate | 1.9 |
| Sodium Dichloroisocianurate | 2 |
| Others* | To 100% |

*Other components include unreacted starting materials and impurities present in commercial sources of the ingredients.

The composition was prepared by admixing all of the ingredients at ambient temperature until a homogeneous composition was obtained in the form of a powder.

### EXAMPLE 14

An effervescent toilet cleaner was provided comprising the following components:

| Ingredient | Wt % active |
|---|---|
| Sodium citrate | 45 |
| Sodium Carbonate | 44 |
| Composition 3 of example 1 | 4 |
| Sodium Xylenesulfonate | 1.9 |
| Sodium Dichloroisocianurate | 1.5 |
| C9-11 Pareth-8 | 1.5 |
| Fragrance | 1 |
| Others* | To 100% |

*Other components include unreacted starting materials and impurities present in commercial sources of the ingredients.

The composition was prepared by admixing all of the ingredients at ambient temperature until a homogeneous composition was obtained in the form of a powder.

1. A free flowing particulate composition comprising at least 50 wt % of one or more amphoteric surfactants and at least 0.1 wt % of one or more chelating agents.

2. The free flowing particulate composition according to claim 1 wherein the one or more amphoteric surfactants are selected from betaine surfactants, sultaine surfactants, amphoacetate surfactants, and mixtures thereof.

3. The free flowing particulate composition according to claim 1 wherein the one or more amphoteric surfactants are selected from betaine surfactants, sultaine surfactants, amphoacetate surfactants, amine oxides and mixtures thereof.

4. The free flowing particulate composition according to claim 2 wherein the one or more amphoteric surfactants comprise a betaine surfactant.

5. The free flowing particulate composition according to claim 1, wherein the one or more amphoteric surfactants comprise cocamidopropyl betaine.

6. The free flowing particulate composition according to claim 1, wherein the one or more amphoteric surfactants are present in an amount of from 50 to 97 wt %, preferably 60 to 90 wt %, more preferably 70 to 85 wt %.

7. The free flowing particulate composition according to claim 1, wherein the chelating agent is a polycarboxylic acid chelating agent.

8. The free flowing particulate composition according to claim 1, wherein the one or more chelating agents may be selected from MGDA, GLDA, IDS, EDTA, DTPA, DETPMP, HEIDA, NTA, AES, ASDA, DTPMPA, STPP AND HEDTA.

9. The free flowing particulate composition according to claim 1, wherein the chelating agent is selected from MGDA, GLDA, IDS, EDTA, DTPA, DETPMP, HEIDA, EDDS, citric acid and salts and mixtures thereof.

10. The free flowing particulate composition according to claim 1, wherein the chelating agent is selected from MGDA, GLDA, EDTA, EDDS, citric acid and salts and mixtures thereof.

11. The free flowing particulate composition according to claim 1, wherein the one or more chelating agents are present in an amount of from 0.1 to 20 wt %.

12. The free flowing particulate composition according to claim 1, which comprises sodium chloride.

13. The free flowing particulate composition according to claim 11, wherein sodium chloride is in an amount of 10 to 30 wt %.

14. The free flowing particulate composition according to claim 1, which comprises less than 5 wt % water.

15. The free flowing particulate composition according to claim 1, which has a degree of caking as measured by the method of example 2 of less than 5%.

16. The free flowing particulate composition according to claim 1, which has a flowability as measured by the method of example 3 of at least 10 g/s.

17. The use of one or more chelating agents to improve the flowability of a particulate composition comprising at least 50 wt % of one or more amphoteric surfactants.

18. A method of preparing a free flowing particulate composition as claimed in claim 1, the method comprising:
(i) providing an aqueous composition comprising one or more amphoteric surfactants and one or more chelating agents; and
(ii) drying the composition obtained in step (i).

19. A detergent formulation comprising a free flowing particulate composition according to claim 1.

20. The detergent formulation according to claim 19 which is a solid personal care composition.

21. A solid toilet block comprising a free flowing particulate composition according to claim 1.

22. The use of a free flowing particulate composition according to claim 1, in household cleaning (such as toilet care), manual dishwashing, laundry, fabric care, kitchen care, carpet cleaning, vehicle care, polishing products, machine cleaning and maintenance, pesticides, insecticides, fungicides, herbicides, oilfield chemical applications, marine applications, personal care or institutional/industrial cleaning formulations.

23. A toilet cleansing device comprising the detergent formulation of claim 19 and an attachment element for attaching the device to a toilet.

24. A method of providing cleansing to a toilet, the method comprising affixing the detergent formulation of claim 19 to a toilet rim or placing the detergent formulation of claim 19 within a toilet cistern.
